(19) United States
(12) Patent Application Publication
(10) Pub. No.: US 2014/0211669 A1
(43) Pub. Date: Jul. 31, 2014

(54) TERMINAL TO COMMUNICATE DATA USING VOICE COMMAND, AND METHOD AND SYSTEM THEREOF

(71) Applicant: Pantech Co., Ltd., Seoul (KR)

(72) Inventors: CHAN-JOO PARK, Seoul (KR); Tae-Han Lee, Goyang-si (KR); Se-II Chu, Seoul (KR)

(73) Assignee: Pantech Co., Ltd., Seoul (KR)

(21) Appl. No.: 14/139,232

(22) Filed: Dec. 23, 2013

(30) Foreign Application Priority Data
Jan. 28, 2013 (KR) 10-2013-0009329

(51) Int. Cl. H04M 3/42

(52) U.S. Cl. CPC H04M 3/42
USPC 370/271

(57) ABSTRACT

A terminal and a method for requesting data using a voice command is disclosed. The method includes setting a voice command mode on an information requestor terminal; receiving, during a data voice call, a voice command; recognizing, with the processor, the voice command to obtain voice command information; and executing a command based on the voice command information. The method further includes determining whether the voice command information is to be executed by an information provider terminal that is different than an information requestor terminal; transmitting the voice command information to the information provider terminal using a communication path used by the data voice call; and receiving a result of the executing from the information provider terminal.

### CROSS-REFERENCE TO RELATED APPLICATION

This application claims the benefit and priority under 35 U.S.C. §119(a) of Korean Patent Application No. 10-2013-0009329, filed on Jan. 28, 2013, the entire disclosure of which is incorporated herein by reference for all purposes.

### BACKGROUND

1. Field

The following description relates to a technology for communicating data, and, more particularly, a terminal capable of communicating data using a voice command, and a method and a system thereof.

2. Description of the Background

Popularization of Long Term Evolution (LTE) has prompted public interests in Voice over LTE (VoLTE). VoLTE refers to a voice call service based on LTE, and is a combination of Voice over Internet Protocol (VoIP) and LTE. Specifically, VoLTE assigns both an audio stream and a video stream in one session and enables two terminals to communicate with each other by transmitting and/or receiving Real-time Transport Protocol (RTP) data packets. Thus, it is possible to transmit and/or receive a high quality voice, video and/or text on a packet basis over VoLTE.

A voice control system of related art has adapted a technique of opening up a new session to transmit specific data to a different terminal. When a user of a terminal wishes to obtain specific data from the different terminal, a user of the different terminal has to process and transmit the specific data. In addition, communicating data between two terminals during a voice call requires executing a new application independently of the voice call. For this reason, if a user wishes to execute an operation during a voice call, it is essential to receive an additional command from the user.

### SUMMARY

Exemplary embodiments of the present invention provide for communicating using a voice command, and a method and a system thereof.

Additional features of the invention will be set forth in the description that follows, and in part will be apparent from the description, or may be learned by practice of the invention.

Exemplary embodiments of the present invention disclose a method, utilizing a processor, for requesting data using a voice command, the method including: setting a voice command mode on an information requestor terminal; receiving, during a data voice call, a voice command; recognizing, with the processor, the voice command to obtain voice command information; and executing a command based on the voice command information.

Exemplary embodiment of the present invention disclose a terminal to request data using a voice command, the terminal including: a voice command mode setting unit configured to set a voice command mode on the terminal; a voice receiving unit configured to receive a voice command during a data voice call; a voice recognizing unit configured to recognize the voice command to obtain voice command information; and a command executing unit configured to execute a command based on the voice command information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a system to communicate data using a voice command according to exemplary embodiments of the present invention.

FIG. 2 is a diagram illustrating a configuration of a terminal to communicate data using a voice command according to exemplary embodiments of the present invention.

FIG. 3 is a diagram illustrating a protocol stack including a control block according to exemplary embodiments of the present invention;

FIG. 4 is a diagram illustrating a screen including a pop-up window of an information providing terminal to receive a confirmation before transmitting a result of execution of a command according to exemplary embodiments of the present invention.

FIG. 5 is a flow chart illustrating a method for requesting data using a voice command according to exemplary embodiments of the present invention.

FIG. 6 is a flow chart illustrating a method for providing data in response to a data request a voice command requesting data according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Descriptions of well-known functions, operations and constructions may be omitted for increased clarity and conciseness.

It will be understood that when an element is referred to as being “connected to” another element, it can be directly connected to the other element, or intervening elements may be present.

Voice command information includes a voice of a user, which a terminal recognizes through voice recognition. For example, if a user speaks “phone call” as a voice command information, the speech is recognized through voice recognition, as “phone call.” Throughout the specification, the commands spoken by a user and processed as voice command information are exemplary. Different spoken command statements can result in the same queries as the spoken command statements exemplified throughout the specification.

Command data includes a command or control data required for a terminal to perform a specific function or operation. That is, the command data is processed data that is able to be recognized by the terminal.

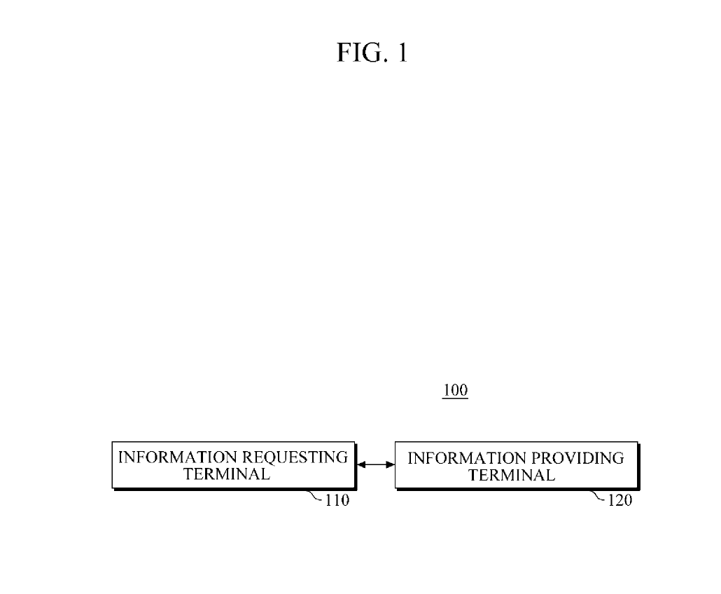

FIG. 1 is a diagram illustrating a configuration of a system to communicate data using a voice command according to exemplary embodiments of the present invention.

Referring to FIG. 1, a system 100 for transmitting and/or receiving data using a voice command includes an information requesting terminal 110 and an information providing terminal 120. Here, suppose that the information requesting terminal 110 and the information providing terminal 120 are in a data voice call. In this case, the data voice call may be a service over mobile Voice over Internet Protocol (mVoIP) or Voice over Long Term Evolution (VoLTE), but aspects of the present invention are not limited thereto.

The information requesting terminal 110 may generate command data based on a voice input by a user during the data voice call, convert the command data into packets to be used for a data voice call, and transmit the packets of the command data to the information providing terminal 120.

The information providing terminal 120 may extract the command data from the packets of the command data received from the information requesting terminal 110, perform a command in accordance with the command data, convert a result of execution of the command into packets, and transmit the packets of the result to the information requesting unit 110.

For example, suppose that, during a VoLTE call using Real-time Transport Protocol (RTP), a user of the information requesting terminal 110 requests a phone number of “John” from a user of the information providing terminal 120. If the user of the information requesting terminal 110 inputs a voice to the information providing terminal 120 by saying, for example, that “Please send me a phone number of John”, the information requesting terminal 110 converts generated command data into RTP packets and transmits the RTP packets to the information providing terminal 120 using User Datagram Protocol (UDP). After that, the information providing terminal receives the RTP packets including the command data, extracts the command data from the RTP packets, transmits a query of “John” to a database storing phone numbers in accordance with the command data, and then receives result data of the query. The information providing terminal 120 converts the result data of the query, which is a phone number of “John,” into RTP packets and transmits the RTP packets to the information requesting terminal 110.

Here, transmitting command data and executing a corresponding command between the information requesting terminal 110 and the information providing terminal 120 may be in accordance with a predetermined standard. If there is no predetermined standard, the information providing terminal 120 that received the command data may display a pop-up window to receive from a user a confirmation on whether to execute a command in accordance with the command data, and in response to the confirmation may execute the command.

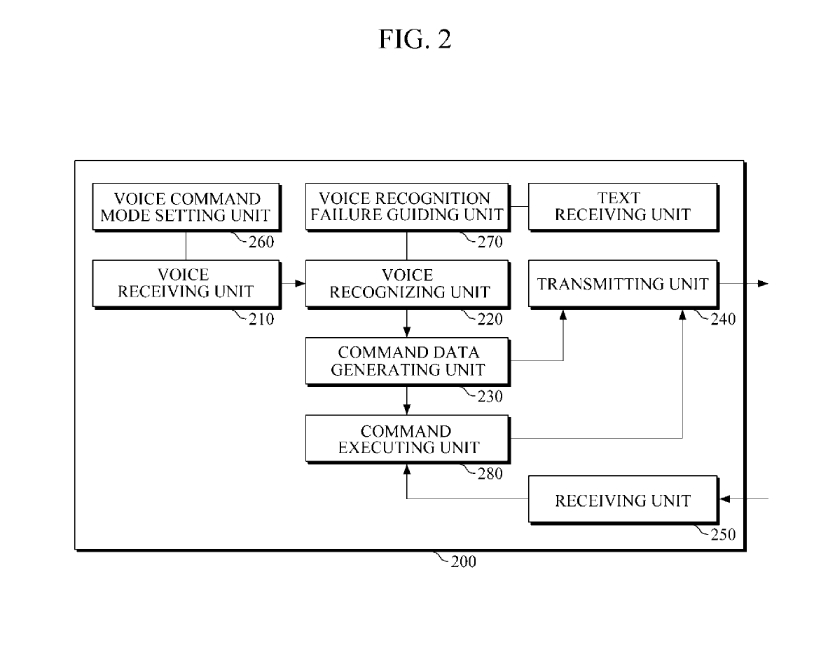

FIG. 2 is a diagram illustrating a configuration of a terminal to communicate data using a voice command according to exemplary embodiments of the present invention.

Referring to FIG. 2, a terminal 200 may include a voice input unit 210, a voice recognizing unit 220, a command data generating unit 230, a transmitting unit 240 and a receiving unit 250.

The voice input unit 210 may receive a voice from a user. The data voice call may be a service over mVoIP or VoLTE, but aspects of the present invention are not limited thereto.

The voice recognizing unit 220 may obtain voice command information from a voice input, for example, by a user, through the voice input unit 210, by analyzing the input voice. For example, the voice recognizing unit 220 may obtain voice command information by digitizing a voice signal, converting the digitized voice signal into text data and making the converted text data to be words.

The command data generating unit 230 may generate the command data by processing the converted text words into voice command information. The voice command information may have a predetermined architecture. For example, the command data generating unit 230 may generate command data by designating an arbitrary protocol standard or converting the voice command information into Extensible Markup Language (XML) data. However, aspects of the present invention are not limited thereto, and various methods may be utilized.

Table 1 as below is an example of XML data converted by the command data generating unit 230 from a voice saying that “Please send me a phone number of John” into XML data.

TABLE 1

```
<Command id =’ 21’ name=’ pull’>
    <contact>
        <name>John</name>
    </contact>
</Command id>
```

The transmitting unit 240 may convert the generated command data into packets and transmit the packets of the command data to a different terminal. For example, during a VoLTE call using RTP, the transmitting unit 240 may convert command data into RTP packets and transmit the RTP packets using UDP to the different terminal.

The receiving unit 250 may receive a result of execution of a command in accordance with the command data from the different terminal.

In some embodiments, the terminal 200 may include a voice command mode setting unit 260. During a data voice call, the voice command mode setting unit 260 may set the terminal 200 to be in a voice command mode to communicate data using a voice command. For example, the voice command mode setting unit 260 may set the terminal 200 to be in a voice command mode by detecting whether a voice received from a user during a data voice call includes a pre-stored command word or whether an event led by pressing a specific button or performing a specific action occurs during a data voice call.

In exemplary embodiments, the terminal 200 may include a voice recognition failure guiding unit 270. By analyzing the received voice, the voice recognition failure guiding unit 270 may check whether voice command information through the voice receiving unit 210 is obtained, and when the voice command information is not obtained, the voice recognition failure guiding unit 270 may generate and display a voice recognition failure message. As such, when a voice is not properly received from a user, for example, due to external noise, through the voice input unit 210, the user may again input a voice command through the voice input unit 210.

If the number of voice recognition failure messages displayed by the voice recognition failure guiding unit 270 exceeds a threshold, or, in other words, if the number of voice recognition failures exceeds a threshold, a text input window may be displayed to receive a text command or command information in the input window. To this end, the terminal 200 may further include a text input unit 119.

In exemplary embodiments, the terminal may include a command executing unit 280. If command data generated in the command data generating unit 230 is a command to be performed relative to the terminal 200, the command executing unit 280 may execute a command in accordance with the generated command data.

For example, if a user wishes to transmit a phone number of “John” to a different terminal, the user inputs a voice to the voice input unit 210 by saying that “I will send a phone number of John”, the input recognizing unit 220 obtains voice command information by analyzing the voice of the user, and then the command data generating unit 230 generates command data by processing the obtained voice command information to have a predetermined architecture. Then, the command executing unit 280 analyzes the generated command data. As the analytical result is that the generated command data is a command requesting phone number data stored in the terminal 200, the command executing unit 280 transmits a query of “John” to a database in which phone numbers are stored, and receives result data of the query. Then, the transmitting unit 240 converts the result data of the query, which is a phone number of John, into RTP packets and transmits the RTP packets to the different terminal.

When there are multiple results of the query, the terminal 200 may display a pop-up window to receive a user's selection of a result of the query to be transmitted, and, even when there is only one result of the query, the terminal 200 may display a pop-up window to receive a user's confirmation on whether to transmit the result of the query.

The receiving unit 250 may extract the command data from the packets of the command data, which are received from the different terminal. In this case, the command executing unit 280 may find out a meaning of the command by parsing the extracted command data, and execute a corresponding command in accordance with the command.

For example, if a “request for a phone number of John” is found by parsing the command data, the command executing unit 280 sends a query of “John” to a database storing phone numbers, and then brings in a result of the query. At this time, when there are multiple results of the query, a pop-up window may be displayed on a screen to receive a user's selection of a result of query to be transmitted, and, even when there is only one result of the query, a pop-up window may be displayed on the screen to receive a user's confirmation on whether to transmit the result of the query.

In exemplary embodiments, if the command executing unit 280 is “executing a memo application execution and recording” after parsing the command data, the command executing unit 280 executes, for example, the memo application and then records data received from the different terminal using the memo application.

In exemplary embodiments, if the command executing unit 280 is “executing a schedule application execution and recording” after parsing the command data, the command executing unit 280 executes the schedule application. If, for example, schedule data reading “Let's meet in A café at 6 pm tomorrow” is received from the different terminal, the command executing unit 280 records the schedule data using the schedule application. In addition, after recording the schedule data, the command executing unit 280 may execute a schedule sharing function or operation to share the schedule with the different terminal.

The transmitting unit 240 may convert a result of execution of a command into packets in the command executing unit 280, and transmit the packets of the result to the different terminal. For example, during a VoLTE call using RTP, the transmitting unit 240 may convert a result of execution of the command into RTP packets and transmit the RTP packets to the different terminal using UDP. UDP is merely an exemplary transmitting method and other various methods, such as, Transmission Control Protocol (TCP), Datagram Congestion Control Protocol (DCCP) and Stream Control Transmission Protocol (SCTP), may be utilized as a transmitting method.

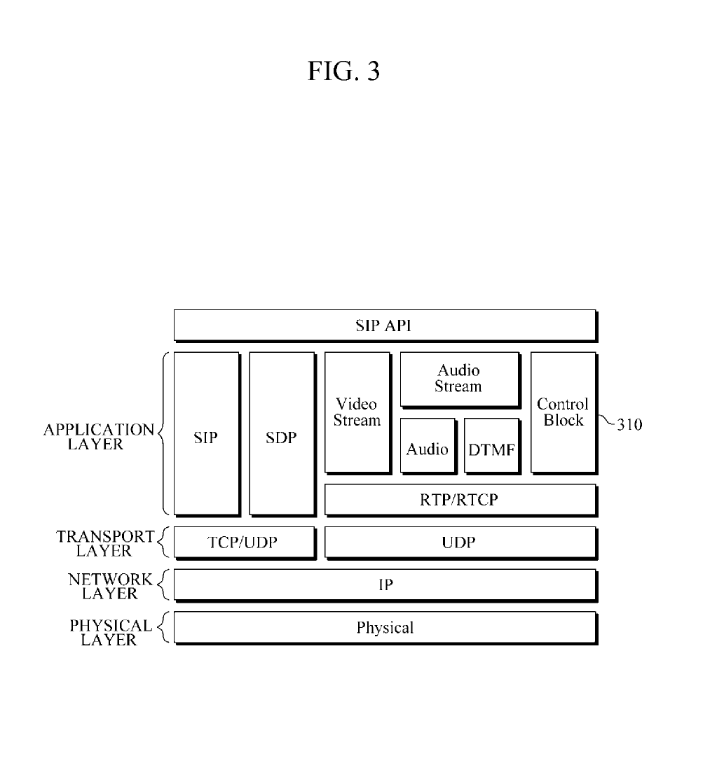

FIG. 3 is a diagram illustrating a protocol stack including a control block according to exemplary embodiments of the present invention.

Referring to FIG. 3, the protocol stack consists of a physical layer, a network layer, a transport layer and an application layer from bottom to top, and a control block 310 is included in a session along with a video stream and an audio stream. Further, the control block 310 may be included in one session with the video stream and the audio stream. Command data is converted into RTP packets and then the RTP packets of the command data are transmitted in the same manner as a video stream and/or an audio stream. Each of the RTP packets includes an RTP header and a payload in accordance with RTP.

Session Initiation Protocol (SIP) is a protocol to manage a multimedia session or multimedia call. That is, SIP is a signal protocol to establish and/or tear down a session. SIP may utilize User Datagram Protocol (UDP) or Transmission Control Protocol (TCP) for transmission. Here, UDP is a connectionless transmitting protocol that allows process-to-process data transmission and error detection, and utilizes an unreliable data transport technique. TCP is a connection-oriented protocol, which assists reliable data transmission, flow control and congestion control as well as services provided by UDP, and utilizes a reliable data transport technique.

Session Description Protocol (SDP) is used in SIP to record additional information relative to a session, and is a protocol designed to be associated with various transmitting protocol, such as, Service Advertising Protocol (SAP), SIP, Real-time Streaming Protocol (RTSP) and Real-time Transport Protocol (RTP).

RTP is a network transport protocol designed for end-to-end, real-time transfer of stream data, and is a standardized packet format necessary to transmit real-time data, such as, audio and video. The RTCP is a control protocol associated with RTP, and provides functions of Quality of Service (QoS), monitoring, collecting receiver information and calculating a transfer rate.

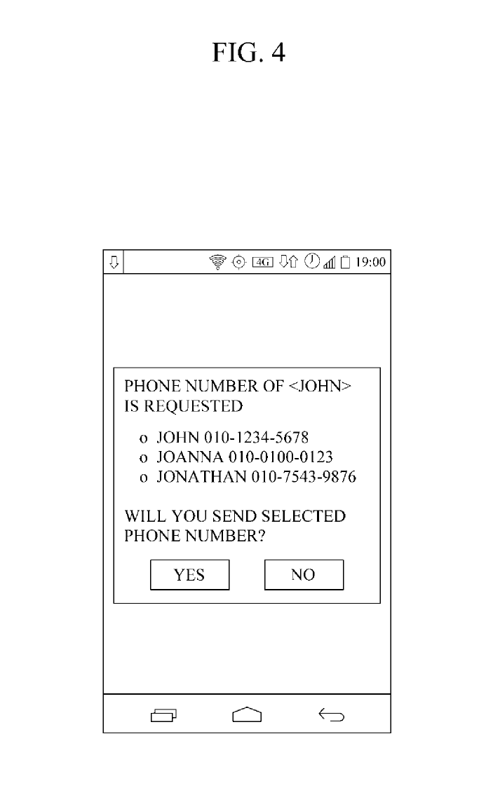

FIG. 4 is a diagram illustrating a screen including a pop-up window of an information providing terminal to receive a confirmation before transmitting a result of execution of the command according to exemplary embodiments of the present invention.

Referring to FIG. 4, an information requesting terminal 110 requests a phone number of John from an information providing terminal 120. If, for example, three results are found by searching for the phone number of John, the information providing terminal 120 may display a pop-up window on a screen to receive a user's selection of one of the results to be transmitted. In some embodiments, even if only one phone number for John is found, the information providing terminal 120 may display a pop-up window on the screen to receive a user's confirmation on whether to transmit the result.

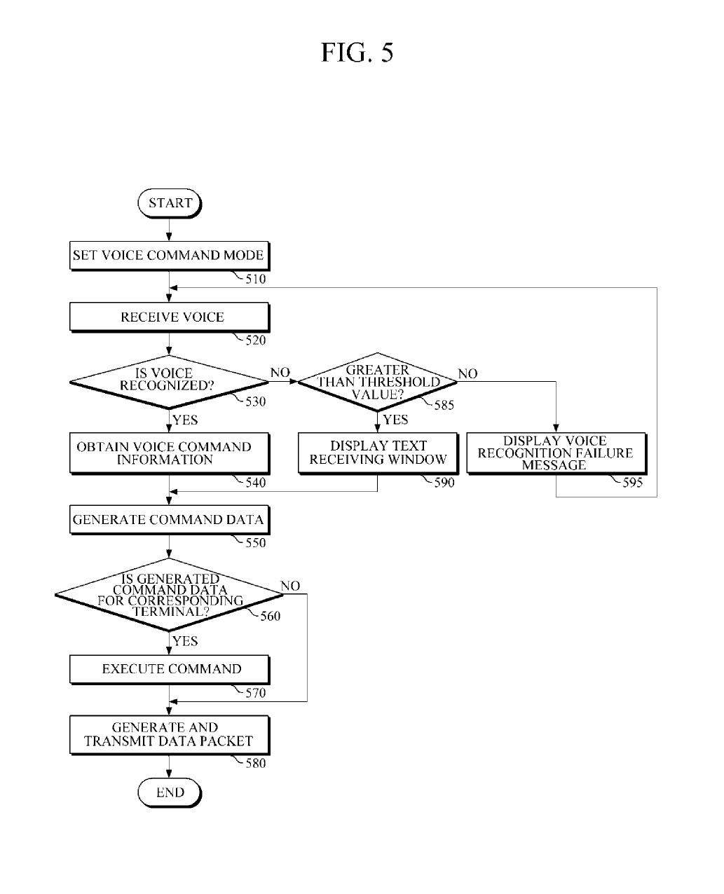

FIG. 5 is a flow chart illustrating a method for requesting data using a voice command according to exemplary embodiments of the present invention.

Referring to FIG. 5, the method for requesting data using a voice command, during a data voice call, includes setting a voice command mode in order to transmit and/or receive data using a voice command in operation 510.

A voice, for example, a user's voice, is received in operation 520. In response to the user's voice being received, whether the received voice is recognizable is checked in operation 530. When the voice has been determined to be recognizable, voice command information is obtained by analyzing the voice in operation 540. For example, voice command information may be obtained by digitizing a voice signal, converting the digitized voice signal into text data and converting converted text data into a keyword.

In operation 550, command data is generated by processing and formatting the obtained voice command information to have a predetermined architecture. For example, command data may be generated by designating an arbitrary protocol standard or converting the voice command information into XML data.

In operation 560, whether the generated command data is designed for a corresponding or remote terminal is determined. In response to the generated command data being determined to be designed for the corresponding terminal, a command is executed in accordance with the command data in operation 570 and then a result of execution of the command is converted into packets and the packets of the result are transmitted in operation 580.

If it is determined in operation 560 that the command data is not designed for the corresponding terminal, the command data is converted into packets and the packets of the command data are transmitted to a different terminal; a terminal that is in a voice call with the corresponding terminal in operation 580.

For example, during a VoLTE call using RTP, a result of execution of the command and the command data are converted into RTP packets and then the RTP packets are transmitted using UDP. Here, UDP is utilized as an exemplary transmission technique. In some embodiments, various transmission techniques may be utilized, including Transmission Control Protocol (TCP), Datagram Congestion Control Protocol (DCCP) and Stream Control Transmission Protocol (SCTP).

In some embodiments, if it is determined in operation 530 that voice command information is not obtained, as the voice cannot be recognized, it is determined in operation 585 whether the number of failed attempts is greater than a threshold value. If it is determined that the number is greater than the threshold value, a text receiving window is displayed to receive a text command from the user in operation 590. If it is determined that the number is less than the predetermined threshold value, a voice recognition failure message is displayed in operation 595.

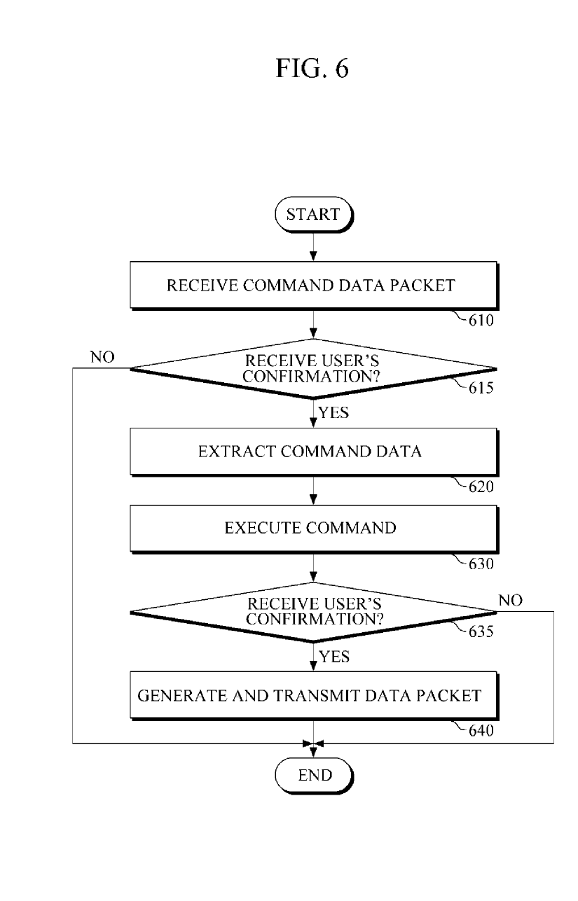

FIG. 6 is a flow chart illustrating a method for providing data in response to a data request using a voice command according to exemplary embodiments of the present invention.

Referring to FIG. 6, the method for providing data in response to a data request using a voice command during a data voice call includes receiving command data packets in operation 610.

In operation 620, command data is extracted from the received command data packets. In operation 630, a command is executed in accordance with the command data by parsing the command data.

Then, a result of execution of the command is converted into packets and the packets are transmitted in operation 640. For example, during a voice call using RTP, the result of execution of the command is converted into RTP packets and then the RTP packets are transmitted using UDP.

When the command data packets are received, a user can confirm whether to execute a command in accordance with the command data in operation 615.

The method may include receiving a user's confirmation on whether to transmit the result of execution of the command to a different terminal in operation 635.

The above-described exemplary embodiments are regarding a data voice call. However, aspects of the present invention are able to be applied in an instant messenger service as well. For example, it is possible to receive a voice from a user during an instant messenger service, recognize the received voice, transmit command data to a different terminal, and receive a result of execution of a command from the different terminal.

It is possible to transmit and/or receive specific data during a call by controlling a different terminal using a voice command, and thus a user's additional operation is not required to transmit and/or receive the specific data. Therefore, the user's convenience may be improved.

In addition, as the above operation is performed during a call, it is possible to use a currently-used session, rather than an additional session, to transmit the specific data, thereby enhancing extensibility and compatibility.

Furthermore, the exemplary embodiments are performed using a voice command, so that an additional screen manipulation is not necessary. The exemplary embodiments are available even when a Liquid Crystal Display (LCD) screen is turned off and electric consumption may be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method, utilizing a processor, for requesting data using a voice command, the method comprising:
setting a voice command mode on an information requestor terminal;
receiving, during a data voice call, a voice command;
recognizing, with the processor, the voice command to obtain voice command information; and
executing a command based on the voice command information.

2. The method of claim 1 further comprising;
determining whether the voice command information is to be executed by an information provider terminal that is different than an information requestor terminal; and
transmitting the voice command information to the information provider terminal using a communication path used by the data voice call;
receiving a result of the executing from the information provider terminal.

3. The method of claim 2, further comprising transmitting the result of the executing to a different terminal.

4. The method of claim 2, further comprising extracting command data from the transmitted voice command information.

5. The method of claim 1, wherein the command information is formatted using eXtensible Markup Language (XML).

6. The method of claim 1, further comprising displaying a result of the executing.

7. The method of claim 1, wherein the recognizing further comprises digitizing the voice command, converting the digitized voice signal into text data and converting the text data into a keyword to obtain the voice command information.

8. The method of claim 1, wherein the recognizing further comprises displaying a text receiving window when failures to recognize the voice command exceed a threshold.

9. The method of claim 1, wherein the data voice call comprises a session and a communication path is included in the session.

10. A terminal to request data using a voice command, the terminal comprising:
a voice command mode setting unit configured to set a voice command mode on the terminal;
a voice receiving unit configured to receive a voice command during a data voice call;
a voice recognizing unit configured to recognize the voice command to obtain voice command information; and
a command executing unit configured to execute a command based on the voice command information.

11. The terminal of claim 10 further comprising;
a command data generating unit configured to determine whether the voice command information is to be executed by an information provider terminal that is different than the terminal; and
a transmitting unit configured to transmit the voice command information to the information provider terminal using a communication path used by the data voice call; and
a receiving unit configured to receive a result of from the information provider terminal.

12. The terminal of claim 11, further comprising wherein the receiving unit transmits the result of the information provider terminal to a different terminal.

13. The terminal of claim 11, wherein the command executing unit is further configured to extract command data from the transmitted voice command information.

14. The terminal of claim 10, wherein the command information is formatted using eXtensible Markup Language (XML).

15. The terminal of claim 10, further comprising a display configured to display a result of the executing.

16. The terminal of claim 10, wherein the voice recognizing unit is further configured to digitize the voice command, convert the digitized voice signal into text data and convert the text data into a keyword to obtain the voice command information.

17. The terminal of claim 10, wherein the voice recognizing unit is further configured to display a text receiving window when failures to recognize the voice command exceed a threshold.

18. The terminal of claim 10, wherein the data voice call comprises a session and a communication path is included in the session.
